(19) United States
(12) Patent Application Publication
(10) Pub. No.: US 2013/0062071 A1
(43) Pub. Date: Mar. 14, 2013

(54) MINIMAL TRAVEL FLOW CONTROL DEVICE

(71) Applicants: Gary L. Rytlewski, League City, TX (US); Stephen Dennis Parks, Houston, TX (US); Russell Alan Johnston, Alvin, TX (US); David James Biddick, Missouri City, TX (US)

(72) Inventors: Gary L. Rytlewski, League City, TX (US); Stephen Dennis Parks, Houston, TX (US); Russell Alan Johnston, Alvin, TX (US); David James Biddick, Missouri City, TX (US)

(73) Assignee: SCHLUMBERGER TECHNOLOGY CORPORATION, Sugar Land, TX (US)

(21) Appl. No.: 13/232,038

(22) Filed: Sep. 14, 2011

(51) Int. Cl. E21B 34/06; B23P 17/00; B23P 21/00; E21B 34/00

(52) U.S. Cl. 166/373; 166/332.8; 29/401.1; 137/15.01

(57) ABSTRACT

A technique facilitates controlling flow in a wellbore with a simplified valve. The design of the valve also enables reduction in the overall length of the valve to improve spatial considerations. The valve comprises a valve component, e.g. a flapper, movable between a closed position and an open position. A flow tube is designed to selectively open the valve component with reduced travel, thus enabling a shortened flow tube. The short flow tube enables use of valve housings, springs, and other valve components having a reduced length.

### BACKGROUND

Hydrocarbon fluids, e.g. oil and natural gas, are obtained from a subterranean geologic formation, referred to as a reservoir, by drilling a well that penetrates the hydrocarbon-bearing formation. Once a wellbore is drilled, various forms of well completion components may be installed to control and enhance the efficiency of producing fluids from the reservoir. One piece of equipment which may be installed is a subsurface safety valve. In many subsurface safety valves, a flow tube is used to open a flapper by fully covering the flapper in an open position. The flow tube must be moved a substantial distance to enable covering of the flapper while butting against a sleeve or housing so that the sleeve or housing, in combination with the flow tube, forms a continuous bore through which production or injection fluid travels.

### SUMMARY

In general, the present disclosure provides a technique for controlling flow in a wellbore with a simplified flow controlling valve. The design of the valve also enables reduction in the overall length of the valve to improve spatial considerations and to reduce construction costs. The valve comprises a valve component, e.g. a flapper, movable between a closed position and an open position. A flow tube is designed to selectively open the valve component with reduced travel, thus enabling a shortened flow tube. The short flow tube enables use of valve housings, springs and other components having a reduced length.

### BRIEF DESCRIPTION OF THE DRAWINGS

Certain embodiments of the disclosure will hereafter be described with reference to the accompanying drawings, wherein like reference numerals denote like elements, and:

FIG. 1 is a schematic illustration of a well system deployed in a wellbore and including a plurality of valves, e.g. a plurality of subsurface safety valves, according to an embodiment of the present disclosure;

FIG. 2 is a schematic example of one type of subsurface safety valve, according to an embodiment of the present disclosure;

FIG. 3 is a schematic example of the subsurface safety valve illustrated in FIG. 1 but in a different operational position, according to an embodiment of the present disclosure;

FIG. 4 is a schematic illustration of another example of the subsurface safety valve, according to an embodiment of the present disclosure;

FIG. 5 is a schematic illustration of another example of a subsurface safety valve, according to an embodiment of the present disclosure;

FIG. 6 is a cross-sectional view of a more detailed embodiment of one example of a subsurface safety valve, according to an embodiment of the present disclosure;

FIG. 7 is a graphical representation of fluid flow lines traveling through the subsurface safety valve, according to an embodiment of the present disclosure; and

FIG. 8 is an illustration of another example of a subsurface valve in the form of an injection valve, according to an embodiment of the present disclosure.

### DETAILED DESCRIPTION

In the following description, numerous details are set forth to provide an understanding of the present disclosure. However, it will be understood by those of ordinary skill in the art that the present minimal travel flow control device may be practiced without these details and that numerous variations or modifications from the described embodiments may be possible.

The disclosure herein generally relates to a system and methodology for controlling fluid flow in a wellbore. Additionally, the system enables simplified design of a valve, e.g. a subsurface safety valve, for controlling fluid flow while reducing equipment cost and thus reducing the cost of production. For example, one of the main sources of cost in a subsurface safety valve is related to the length of its components. The system described herein reduces the overall length of flow control valves by utilizing a design which allows several components of the valve to be shortened while still achieving all desired functional requirements.

A subsurface safety valve can be used to allow full wellbore access based on a control signal from the surface while also enabling flow shut off when the control signal is interrupted or stopped. According to one embodiment of the subsurface safety valve described herein, a flow tube is employed to open a valve component, such as a flapper. However, the overall distance traveled by the flow tube is limited so that the flow tube is not moved over the entire flapper. Instead, flow tube travel is restricted to movement sufficient to open the flapper without allowing produced or injected fluids to impinge on the flapper in a detrimental manner

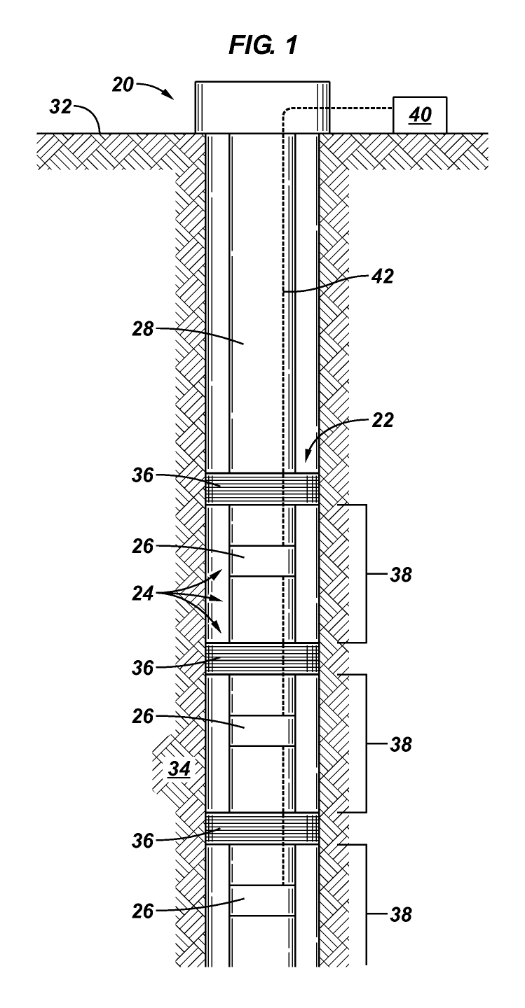

Referring generally to FIG. 1, an embodiment of a well system 20 is illustrated. The well system 20 comprises a completion 22 having a plurality of completion components 24 including a plurality of flow controlling valves 26, such as subsurface safety valves. The completion 22 may be part of an overall tubing string 28 deployed in a wellbore 30 extending downwardly from a surface location 32. The wellbore 30 may comprise vertical wellbore sections and/or deviated, e.g. horizontal, wellbore sections that extended into a surrounding subterranean formation 34. In the specific example illustrated, the completion 22 also may comprise one or more packers 36 used to isolate a plurality of well zones 38 along wellbore 30. The completion 22 may be employed to facilitate production and/or injection of fluids from and/or into the surrounding formation 34 at the plurality of well zones 38. In some embodiments, a surface control system 40 provides a signal via a communication line 42 to the subsurface safety valve 26 to maintain the valves in an open flow position. If the signal is interrupted or stopped, the corresponding valve or valves 26 is closed to shut off flow. By way of example, communication line 42 may be a hydraulic communication line, an electrical communication line, or a wireless communication line.

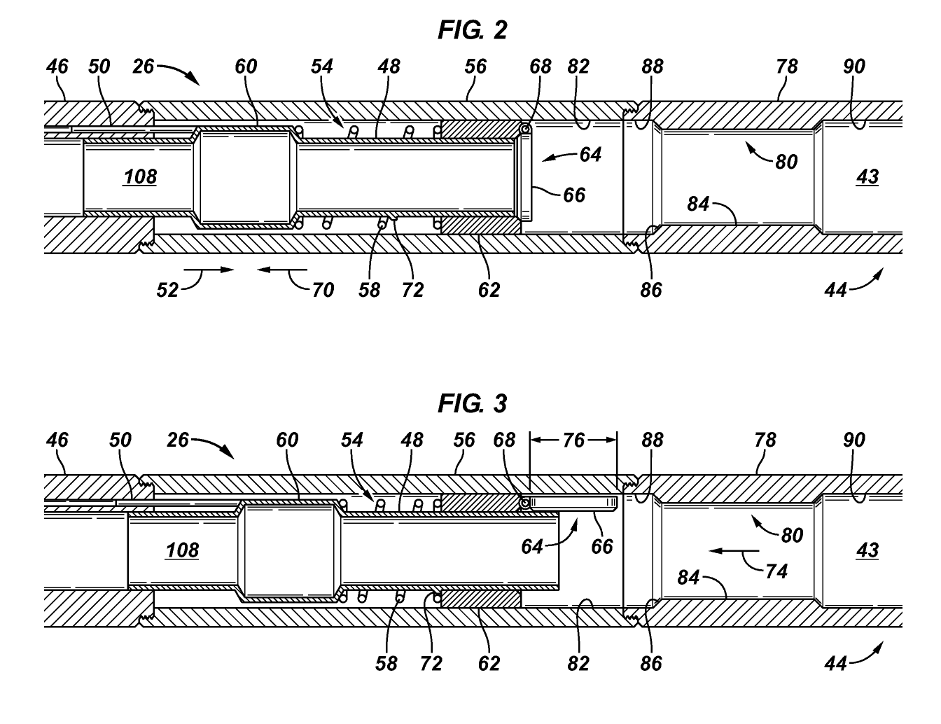

Referring also to FIG. 2, a schematic illustration is provided of an embodiment of flow controlling valve 26. In this example, valve 26 is a subsurface safety valve having an internal flow passage 43 which is disposed generally longitudinally through a subsurface safety valve housing 44 of valve 26 to accommodate flow along the interior of completion 22. The subsurface safety valve 26 also may comprise a hydraulic chamber housing portion 46 of housing 44 and a flow tube 48 slidably received in the hydraulic chamber housing 46. A hydraulic piston 50 is coupled to the flow tube 48 and to the hydraulic chamber housing 46. For example, the hydraulic piston 50 may be slidably received in the hydraulic chamber housing 46 for slidable movement in response to pressurized fluid in the hydraulic chamber housing 46. Fluid in hydraulic chamber housing 46 may be selectively pressurized and applied against the hydraulic piston 50 to move the hydraulic piston 50 and thus the flow tube 48 in a first direction represented by arrow 52. In the specific embodiment illustrated in FIG. 2, hydraulic piston 50 comprises a rod piston. It should be noted that hydraulic piston 50 is an example of an actuator, but other types of actuators, e.g. electric actuators, may be used to move the flow tube 48.

In the example illustrated, subsurface safety valve 26 further comprises a spring 54 located within a surrounding valve housing portion 56 of overall housing 44. By way of example, spring 54 may comprise a coil spring 58 positioned around the flow tube 48 between an expanded portion 60 of the flow tube 48 and an abutment 62 extending radially inwardly from valve housing 56. The subsurface safety valve 26 further comprises a valve component 64 positioned within valve housing 56 to selectively open or close internal flow passage 43. In the specific example illustrated, valve component 64 comprises a flapper 66 pivotably mounted within the surrounding valve housing 56 at a pivot point 68 for pivotable motion between a position blocking flow along internal flow passage 43 and an open position allowing flow along the internal flow passage 43.

Flow tube 48 is positioned so as to force the flapper 66 to the open position when moved in the first direction 52. Spring 54 resists motion in this first direction by exerting a force, as represented by arrow 70, in a direction generally opposite to the first direction represented by arrow 52. The movement of flow tube 48 in the first direction 52 is limited to enable use of a shortened flow tube 48 relative to longer, conventional flow tubes. Movement of the flow tube 48 in the first direction 52 may be limited by a suitable mechanism 72, e.g. by limiting the stroke length of hydraulic piston 50, by placing an abutment/stop in the path of movement of flow tube 48, or by other suitable mechanisms. In some embodiments, movement of the flow tube 48 is limited to movement just past pivot point 68.

As illustrated in FIG. 3, movement of flow tube 48 in the direction of arrow 52 forces flapper 66 to an open position which allows fluid flow along internal flow passage 43 in a direction indicated by arrow 74. However, the movement limiting mechanism 72 limits movement of the flow tube 48 to a position sufficient to open the flapper 66 but without covering the flapper 66. For example, the movement of flow tube 48 in the first direction 52 may be limited to less than half and often less than one third of a length 76 of the flapper 66. Length 76 is measured from a side of the flapper 66 proximate pivot point 68 to a distal side of the flapper 66 opposite pivot point 68. If the flapper 66 is circular, the movement of flow tube 48 is limited to less than half the diameter and often less than one third of the diameter of the flapper 66.

Referring again to FIGS. 2 and 3, the subsurface safety valve further comprises an inlet housing 78 which may be part of subsurface safety valve housing 44. For example, inlet housing 78 may be coupled to valve housing 56 by a suitable fastener mechanism, such as a threaded engagement. In the embodiment illustrated, inlet housing 78 is positioned upstream of flapper 66 and is designed to maintain the majority of fluid flow along internal flow passage 43 of subsurface safety valve 26. The inlet housing 78 may comprise a flow control section 80 which helps maintain a smooth flow of fluid in the direction of arrow 74 past flapper 66. The flow control section 80 also helps maintain smoothly flowing fluid past a recess 82 which receives flapper 66 when the flapper is in the open position radially outside of the internal flow passage 43 (see FIG. 3). The flow control section 80 ensures the smooth fluid flow without incurring any substantial recirculation in the vicinity of flapper 66 and recess 82.

The flow control section 80 may comprise a variety of features along the portion of internal flow passage 43 within inlet housing 78. By way of example, the flow control section 80 may comprise a contoured interior of the inlet housing 78, e.g. a contoured interior having a reduced diameter portion 84 immediately preceding a transition 86 to a larger diameter portion 88. In the specific example illustrated, the flow control section 80 further comprises an expanded diameter portion 90 immediately upstream of reduced diameter portion 84. When fluid flows in the direction of arrow 74 through the reduced diameter portion 84 and across the transition 86 to larger diameter portion 88, the primary fluid flow remains centralized. This allows the fluid to move smoothly past flapper 66 and recess 82 with minimal recirculation even though flow tube 48 covers only a small portion of the flapper 66. The use of flow control section 80 effectively allows the recessed area 82 to remain open to fluid flowing along internal flow passage 43 with minimal interference to flow.

By reducing the distance the flow tube 48 travels, the overall length of the flow tube 68 can be shortened, thus shortening the length of the overall subsurface safety valve 26. In many applications employing valve 26, the distance traveled by the flow tube 48 in first direction 52 can be reduced to one third or less of the stroke of a conventional valve. However, reducing the flow tube travel distance also facilitates additional component changes that further reduce the overall valve length. For example, the length of hydraulic chamber housing 46 is reduced because the length of hydraulic piston 50 (and the length of the corresponding bore which slidably receives hydraulic piston 50 in hydraulic chamber housing 46) can be reduced while still accommodating the shorter travel distance of flow tube 48. Additionally, flow tube 48 and the surrounding valve housing portion 56 can be shortened and directional stops, e.g. see mechanism 72, can be moved closer together. Similarly, the spring 54 can be shorter because the percent of compression required is less, and the shorter spring 54 again requires a shorter surrounding valve housing 56.

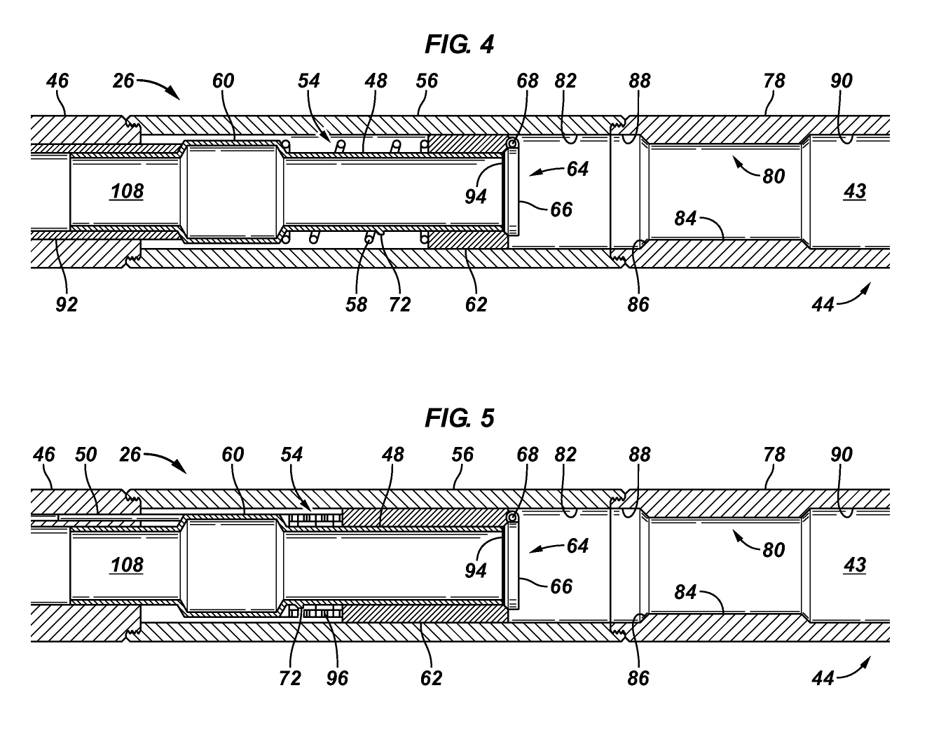

Depending on the specific application of subsurface safety valve 26, a variety of valve components and features may be added or changed to provide desired valve characteristics. For example, the rod-type hydraulic piston 50 illustrated in FIGS. 2 and 3 may be replaced with an annular piston 92 disposed about or integral with the flow tube 48 on the hydraulic chamber housing side of expanded portion 60, as illustrated in FIG. 4. In this example, the annular piston 92 may be coupled with or integrally formed with the flow tube 48 to create an annular valve.

As further illustrated in FIG. 4, the flapper 66 also may be designed with a contoured portion 94. The contoured portion 94 is positioned for engagement with the flow tube 48 and may be designed to affect the motion of the flapper during closing and/or opening. For example, contoured portion 94 may comprise a raised, curvilinear portion designed to rapidly move the flapper out of the internal flow passage 43 during opening. The contoured portion 94 can be used to further minimize the travel of flow tube 48 when transitioning flapper 66 to the open position within recess 82.

Examples of other changes to subsurface safety valve 26 may include changes to spring 54. For example, instead of using coil spring 58, spring 54 may comprise a wave spring 96, as illustrated in FIG. 5. In some applications, wave springs 96 can be used to provide a desired counterforce to movement in the first direction 52 with a further reduction in the space requirement. Depending on the application, a variety of other springs 54, e.g. pneumatic springs, also may be incorporated into the design of subsurface safety valve 26.

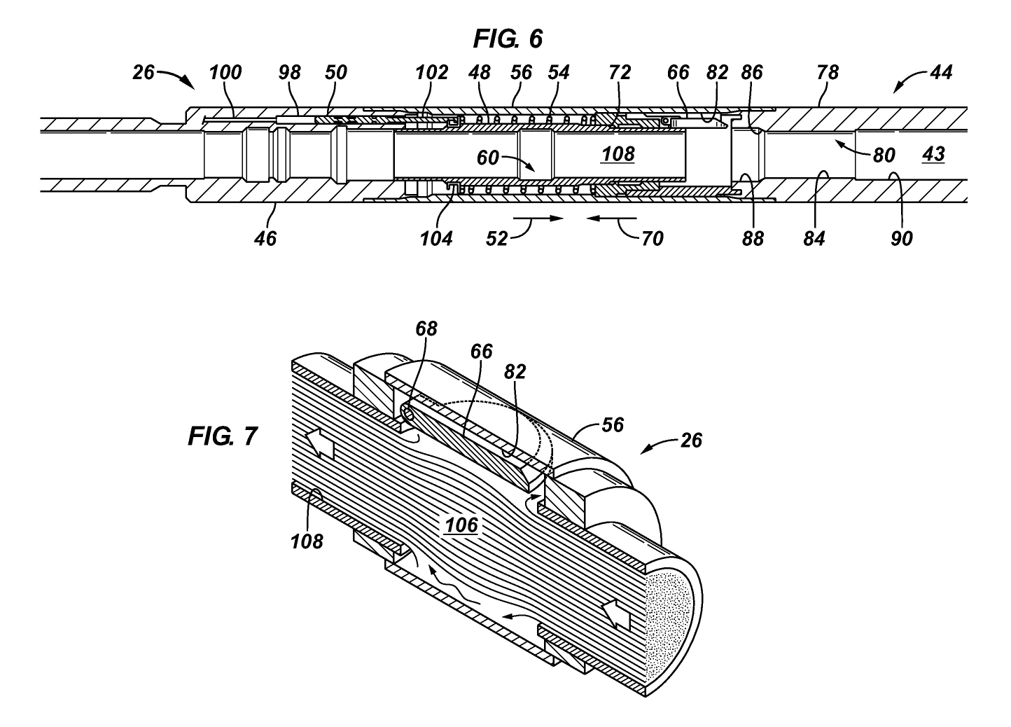

Referring generally to FIG. 6, a more detailed example of subsurface safety valve 26 is illustrated. In this example, hydraulic chamber housing 46 is illustrated as having a bore 98 for slidably receiving rod-type hydraulic piston 50. The bore 98 communicates with a port 100 through which pressurized hydraulic fluid may be selectively introduced to drive the piston 50 in the first direction 52. The piston 50 comprises a rod extension 102 joined to flow tube 48 via a coupling link 104. In this example, the coupling link 104 may be designed to engage spring 54, thus providing the resistance force in direction 70.

As illustrated, movement of flow tube 48 is limited by mechanism 72 which is in the form of an abutment generally aligned with expanded portion 60 of flow tube 48. Accordingly, the flow tube is able to cover only a small portion of flapper 66 when the subsurface safety valve 26 is transitioned to its fully open position. For example, flow tube 48 moves along less than one third of the length of flapper 66 to leave recess 82 substantially open to flow. However, the inlet housing 78 is again designed with flow control section 80 to ensure the flow of fluid along internal flow passage 43 moves smoothly past flapper 66 and recess 82. By way of example, the flow control section 82 may comprise reduced diameter portion 84 directly upstream of transition 86 and expanded portion 88.

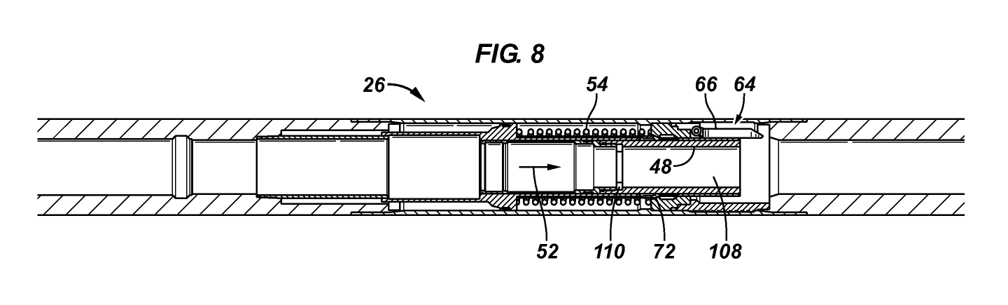

As discussed, one way of substantially improving flow through the subsurface safety valve 26 when the flapper remains uncovered is to provide reduced inside diameter portion 84 upstream of the flapper recess 82 in combination with transition 86. In some designs, transition 86 is formed as an abrupt transition or as a sharp edged transition. In FIG. 7, the flow of fluid through subsurface safety valve 26 and specifically past recess 82 and open flapper 66 is represented by pathlines 106. The pathlines 106 indicate that a vast majority of the flow remains centralized, moves smoothly past recess 82, and flows directly into an interior 108 of flow tube 48. As indicated, very few pathlines recirculate behind the flapper 66 in recess 82. The design of inlet housing 78 and flow control section 80 minimizes the undesirable recirculation in the flapper recess 82. The flow control section 80 can be sized and designed according to fluid type and Reynolds number. In other applications, e.g. injection valve applications, the valve 26, e.g. an injection valve, can be designed so the flow tube 48 above the flapper recess 82 is similarly sized according to fluid type and Reynolds number. In such a case, there would be a smooth transition from portion 88 to portion 84 to minimize near wall flow velocity and to thus reduce the potential for erosion.

In FIG. 8, another embodiment of flow controlling valve 26 is illustrated. In this example, valve 26 is in the form of an injection valve that does not require any signal from the surface other than pumping a flow of fluid through the valve from the surface. This latter embodiment utilizes several valve components which are the same or similar to valve components described in the embodiments set forth above and common reference numerals have been used.

Referring again to FIG. 8, a flow restrictor 110 may be coupled to flow tube 48, as illustrated. When a sufficient flow of injection fluid is pumped down through interior 108 of flow tube 48, the flow restrictor 110 creates sufficient force acting on flow tube 48 in an axial direction to compress spring 54. As spring 54 is compressed, the flow tube 48 moves into engagement with the valve component 64, e.g. flapper 66, and forces the valve component to an open flow position, as illustrated. As with the other embodiments described herein, movement of the flow tube 48 in the first direction 52 is limited to movement along only a portion of the valve component 64. Movement in the first direction 52 may be limited by a suitable stop mechanism, such as the mechanism 72 described above.

Various other features may be added and/or substituted to facilitate fluid flow through the subsurface safety valve along internal flow passage 43. For example, the transition to the flapper recess 82 can be contoured in a variety of ways to produce a more concentrated flow. The desired transitions may be created by appropriately forming the flow control section 80. In some embodiments, for example, the flow control section 80 may be designed to include an orifice or a venturi. Each of these approaches facilitate construction of a substantially shorter subsurface safety valve 26 while minimizing any potential detrimental effects with respect to fluid flow through the valve.

It should be noted that one or more valves 26 may be used as flow controlling valves in a variety of well related applications, including production applications and injection applications. The types of completion components 24 that are used in combination with the valve or valves 26 can vary substantially depending on the objectives of a given well application and on the environment in which the operation occurs. Flapper 66 has been referenced in several of the embodiments described above. However, other types of pivoting or rotating valve components 64 may be used in cooperation with a flow tube designed to control opening and closing of the valve component via axial translation. Other components of each subsurface safety valve 26 also may be changed, combined, separated, or otherwise adjusted to accommodate the requirements of a given application while maintaining the beneficial design of the shorter, more economical valves 26 described above.

Although only a few embodiments of the present invention have been described in detail above, those of ordinary skill in the art will readily appreciate that many modifications are possible without materially departing from the teachings of this invention. Accordingly, such modifications are intended to be included within the scope of this invention as defined in the claims.

What is claimed is:

1. A system for controlling fluid flow in a well, comprising:
a subsurface safety valve having an internal flow passage disposed longitudinally through the subsurface safety valve, the subsurface safety valve further comprising:
a hydraulic chamber housing;
a flow tube slidably received in the hydraulic chamber housing;
a hydraulic piston coupled to the flow tube and located in the hydraulic chamber housing, wherein pressurized fluid is selectively applied against the hydraulic piston within the hydraulic chamber housing to move the flow tube in a first direction;
a spring positioned to bias the flow tube in a second direction generally opposite the first direction;
a flapper pivotably mounted within a surrounding valve housing for pivotable movement between a position blocking flow along the internal flow passage and a position allowing flow along the internal flow passage, the flow tube being positioned to force the flapper to the open position when moved in the first direction, the movement of the flow tube in the first direction being limited to movement along the flapper less than a full length of the flapper.

2. The system is recited in claim 1, wherein the subsurface safety valve further comprises an inlet housing positioned upstream of the flapper, the inlet housing including a portion of the internal flow passage and having a reduced diameter portion immediately preceding a transition to a larger diameter portion to minimize recirculation.

3. The system is recited in claim 1, wherein the flapper comprises a contoured portion positioned for engagement with the flow tube, the contoured portion being designed to more rapidly move the flapper out of the internal flow passage during opening.

4. The system is recited in claim 1, wherein the spring comprises a coil spring.

5. The system is recited in claim 1, wherein the spring comprises a wave spring.

6. The system as recited in claim 1, wherein the hydraulic piston comprises a rod piston.

7. The system as recited in claim 1, wherein the hydraulic piston comprises an annular piston.

8. A method of forming a flow control valve for use in a well, comprising:
pivotably mounting a flapper in a subsurface valve housing for movement between a closed, flow blocking position and an open position pivoted out of a flow path through the subsurface valve housing;
slidably mounting a flow tube in the subsurface valve housing so the flapper is selectively forced into the open position when the flow tube is moved past a pivot point of the flapper; and
limiting movement of the flow tube so the flow tube only partially covers the flapper when the flapper is forced to the open position.

9. The method as recited in claim 8, wherein pivotably mounting comprises mounting the flapper for movement into a recessed area radially outward of the flow path through the subsurface valve housing.

10. The method as recited in claim 9, wherein limiting movement comprises limiting movement of the flow tube so the recessed area remains open to fluid flowing along the flow path.

11. The method as recited in claim 10, further comprising limiting recirculation of fluid in the recessed area during fluid flow along the flow path by positioning an inlet housing upstream of the flapper and the recessed area.

12. The method as recited in claim 11, further comprising forming the inlet housing with an internal flow path having a sequential expanded diameter portion, a reduced diameter portion, and a second expanded diameter portion located immediately upstream of the recessed area.

13. The method as recited in claim 8, wherein pivotably mounting comprises mounting the flapper in an injection valve housing.

14. The method as recited in claim 8, wherein slidably mounting comprises slidably mounting the flow tube in a hydraulic chamber housing portion of the subsurface valve housing; and actuating the flow tube with a hydraulic piston slidably mounted in the hydraulic chamber housing portion.

15. A method of reducing the length of a flow control valve, comprising:
opening a flapper in a valve housing with a shorter flow tube by restricting movement of the flow tube to cover less than half the flapper when the flapper is forced to an open position;
reducing the length of a piston used to actuate the shorter flow tube to the open position due to the reduced travel length of the shorter flow tube; and
providing a counterforce against opening the flapper with a spring acting against movement of the shorter flow tube in the opening direction, the spring having a shortened length due to the reduced travel length of the shorter flow tube.

16. The method as recited in claim 15, further comprising utilizing an inlet housing upstream of the flapper, the inlet housing having a contoured interior to reduce recirculation as fluid flows past the flapper.

17. The method as recited in claim 16, wherein utilizing comprises forming the contoured interior with a reduced diameter portion upstream of a transition to a downstream, expanded diameter portion proximate the flapper.

18. The method as recited in claim 15, wherein providing comprises providing the counterforce with a wave spring.

19. The method as recited in claim 15, further comprising forming the piston as an annular piston which seals against the flow tube.

20. The method as recited in claim 15, further comprising operating the flapper within a tubing string located in a wellbore.
